(19) United States
(12) Patent Application Publication
(10) Pub. No.: US 2016/0082954 A1
(43) Pub. Date: Mar. 24, 2016

(54) METHOD FOR CONTROLLING OPERATIONS OF MULTIPLE MACHINES

(71) Applicant: Caterpillar Inc., Peoria, IL (US)

(72) Inventors: Alexander T. Rennemann, Peoria, IL (US); Christopher R. Barrett, Trafalgar South (AU)

(73) Assignee: Caterpillar Inc., Peoria, IL (US)

(21) Appl. No.: 14/955,038

(22) Filed: Nov. 30, 2015

(51) Int. Cl. B60W 30/08; E02F 9/24; E02F 9/20

(52) U.S. Cl. CPC B60W 30/08; E02F 9/2054; E02F 9/24; B60W 2300/17; B60W 2510/20; B60W 2510/30; B60W 2530/10

(57) ABSTRACT

A method for controlling operations of a first machine and a second machine at a worksite is provided. The method includes establishing a communication between the first machine and the second machine. The method further includes communicating a signal indicative of one or more machine parameters between the first machine and the second machine. The method includes communicating a signal indicative of multiple implement parameters between the first machine and the second machine. The method further includes comparing the one or more machine parameters and the multiple implement parameters of at least one of the first machine and the second machine with a predefined value. The method further includes determining one or more outputs based on the comparison. The method further includes controlling the operation of at least one of the first machine and the second machine based on the one or more outputs to minimize an impact.

### TECHNICAL FIELD

The present disclosure relates to controlling push-pull operations of multiple machines in a worksite, and more particularly relates to a method of utilizing machine to machine communication and a variety of variables to minimize impact during push-pull operation.

### BACKGROUND

Machines such as, for example, excavators, loaders, scrapers, dozers, motor graders, haul trucks, and other types of heavy machinery are used to perform various earth moving operations. Generally, two or more machines perform a predetermined task in a worksite by physically contacting each other. In such earth moving operations, operators of the machines may need to precisely and accurately control operation of the machines, which may be difficult for untrained or inexperienced operators. Also, when performing push-pull operations, machines can collide at high velocities and damage one or both of the machines. This may lead to unproductive operation of the machines in the work site. Further, performing the predetermined tasks may become expensive, labor intensive, and time consuming.

U.S. Pat. No. 8,170,756 (the '756 patent) discloses a method for enhancing productivity of an excavating operation. The method includes establishing a machine-to-machine communication system for a fleet of machines, including at least two machines. The method also includes removing material during the excavating operation with at least a first machine of the fleet of machines. The method additionally includes operating a second machine of the fleet of machines in a mode involving contact between at least the first machine and the second machine. The method further includes employing the machine-to-machine communication system to affect controlled contact between at least the first machine and the second machine. However, the '756 patent does not disclose controlling machine-to-machine operations in a worksite to perform the predetermined task.

### SUMMARY OF THE DISCLOSURE

In one aspect of the present disclosure, a method for controlling operations of a first machine and a second machine at a worksite is provided. The method includes receiving a signal indicative of a location of the first machine and the second machine at the work site. The method further includes determining if the location of the first machine and the second machine is within a threshold distance at the worksite. The threshold distance is defined based on a predetermined area around at least one of the first machine and the second machine. The method further includes establishing a communication between the first machine and the second machine, if the location of the first machine and the second machine is within the threshold distance. The method further includes communicating a signal indicative of one or more machine parameters between the first machine and the second machine, wherein the one or more machine parameters includes ground speeds of the first machine and the second machine. The ground speeds are determined based on a slippage of ground engaging members of the first machine and the second machine. The method further includes communicating a signal indicative of multiple implement parameters between the first machine and the second machine. The multiple implement parameters include a position of an implement system of at least one of the first machine and the second machine. The position of the implement system includes a height and an angle of a blade with respect to a frame of at least one of the first machine and the second machine. The multiple parameters further include a command to a steering system of at least one of the first machine and the second machine. The multiple implement parameters further include a payload of at least one of the first machine and the second machine. The multiple implement parameters further include a cycle segment of at least one of the first machine and the second machine. The method further includes comparing the one or more machine parameters and the multiple implement parameters of at least one of the first machine and the second machine with a predefined value. The method further includes determining one or more outputs based on the comparison of the one or more machine parameters and the multiple implement parameters with the predefined value. The method further includes controlling the operation of at least one of the first machine and the second machine based on the one or more outputs to minimize an impact caused during pushing or pulling of the first machine by the second machine or the second machine by the first machine at the worksite.

Other features and aspects of this disclosure will be apparent from the following description and the accompanying drawings.

### BRIEF DESCRIPTION OF THE DRAWINGS

FIG. 1 is a schematic view of a worksite including a first machine and a second machine working therein, in accordance with the concepts of the present disclosure;

FIG. 2 is a block diagram of a system for controlling a pushing operation or a pulling operation between the first machine and the second machine, in accordance with the concepts of the present disclosure; and

FIG. 3 is a flowchart of a method of controlling the pushing or the pulling operations of the first machine and the second machine at the worksite.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

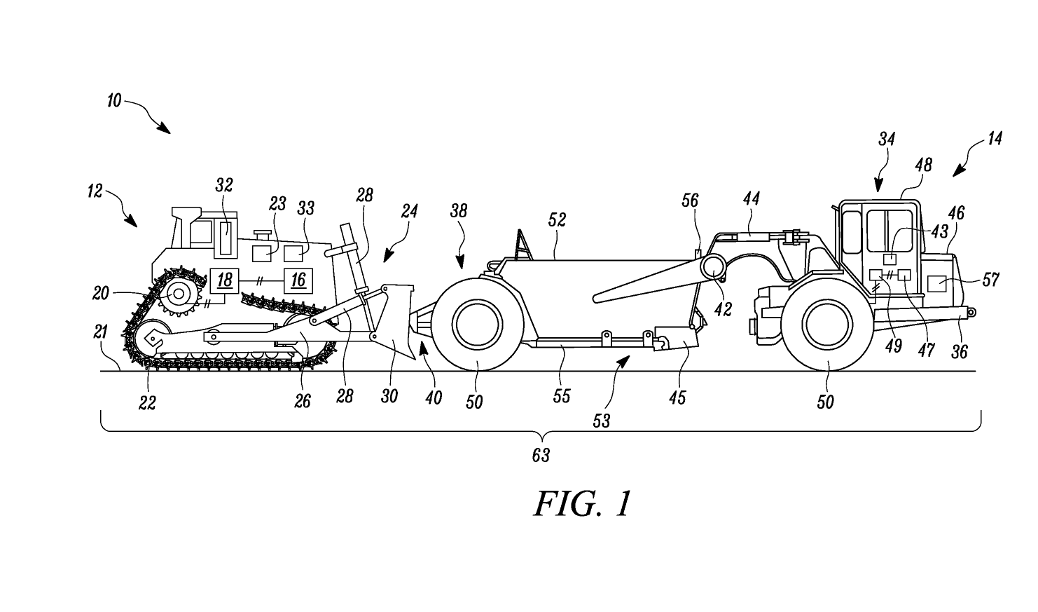

FIG. 1 illustrates a schematic view of a worksite 10. The worksite 10 includes a first machine 12 and a second machine 14. At least one of the first machine 12 and the second machine 14 is adapted to perform various earth moving operations at the worksite 10. The worksite 10 may also include multiple work machines, such as track-type tractors and wheel tractor scrapers for performing various predetermined tasks. The worksite 10 may be, for example, a mine site, a landfill, a quarry, a construction site, or any other type of worksite known in the art. For example, the predetermined tasks may include a compacting operation, a clearing operation, a leveling operation, a hauling operation, a digging operation, a loading operation, or any other type of operation that alter current geography at the worksite 10.

In the present disclosure, the first machine 12 is a track type tractor and the second machine 14 is a wheel tractor scraper. Further, the first machine 12 may embody any wheeled or tracked machine associated with mining, agriculture, forestry, construction, and other industrial applications. In an example, the first machine 12 may have high weight-to-horsepower ratios to push or pull more loads compared to the second machine 14. However, it may be contemplated that the first machine 12 and the second machine 14 may be any type of machine that may perform the predetermined tasks in the worksite 10.

The first machine 12 includes a first power source 16, a first transmission system 18, and a propulsion system 20. In an example, the first power source 16 may be, for example, a diesel engine, a gasoline engine, a gaseous engine or any other type of engine known in the art. The first transmission system 18 is coupled to the first power source 16. The first transmission system 18 includes a gear drive for transmitting a drive torque from the first power source 16 to the propulsion system 20. As shown in FIG. 1, the propulsion system 20 includes a track 22 having ground engaging elements for propelling the first machine 12 over a ground surface 21. Further, the first machine 12 includes a steering system 23. The steering system 23 is operated based on an input command provided by an operator of the first machine 12. Further, the first machine 12 includes an implement system 24 having a lift arm 26, one or more hydraulic actuators 28, and a blade 30, which is a ground engaging tool.

The blade 30 is used for performing various earth moving operations on the ground surface 21. In an example, a height and an angle of the blade 30 may be adjusted with respect to a frame of the first machine 12. The one or more hydraulic actuators 28 are used for moving the implement system 24 based on an input command provided by the operator of the first machine 12. The first machine 12 includes a first controller 33 disposed on an operator cabin 32. The first controller 33 is programmed for controlling various operation of the machine and the implement system 24 based on an input command received from the operator.

Further, the second machine 14 includes a tractor portion 34 with a front frame section 36, and a scraper portion 38 with a rear frame section 40, that are pivotally coupled through an articulation hitch 42. Further, the second machine 14 includes a steering system 43. The steering system 43 is operated based on an input command provided by the operator of the second machine 14. One or more steering cylinders 44 are mounted between the tractor portion 34 and the scraper portion 38. As shown, the front frame section 36 has an enclosure 46. A second power source 47 is installed inside the enclosure 46 to provide power for propulsion. In an example, the second power source 47 may be, for example, a diesel engine, a gasoline engine, a gaseous engine or any other type of engine known in the art. A second transmission system 49 is coupled to the second power source 47. The second transmission system 49 includes a gear drive for transmitting a drive torque from the second power source 47 for the propulsion of the second machine 14.

The front frame section 36 supports an operator station 48. Also, the second machine 14 is mounted on a set of ground engaging members 50, such as wheels, for mobility. In an example, the tractor portion 34 is driven by the second power source 47 which may drive the ground engaging members 50. Furthermore, the second machine 14 may include another power source (not shown) to drive the scraper portion 38 which may also drive the ground engaging members 50. Also, the alternate power source may be used for performing earth moving operation at the worksite 10. As shown in FIG. 1, the rear frame section 40 supports a bowl 52. Alternatively, an auger, a conveyor, a spade, and the like, may be used. Further, the second machine 14 includes an implement system 53. The implement system 53 includes a blade 55 and an apron 45. In an example, the apron 45, when raised, may provide an opening for loading an spreading while performing the earth moving operation at the worksite 10. Also, the apron 45, when lowered during hauling may prevent spillage of load. In an example, a height and an angle of the blade 55 may be adjusted with respect to a frame of the second machine 14. The blade 55 is coupled to the bowl 52. Further, the apron 45 is coupled to the blade 55. More specifically, a set of hydraulic or pneumatic cylinders 56 is coupled to the bowl 52. The second machine 14 includes a second controller 57 mounted on the second machine 14. Further, the blade 30 of the first machine 12 and the rear frame section 40 of the second machine 14 is coupled with each other to perform the predetermined tasks at the worksite 10. In an example, the predetermined tasks may be the pushing or the pulling operation. As such, the first machine 12 and the second machine 14 may perform the pushing or the pulling operation at the worksite 10.

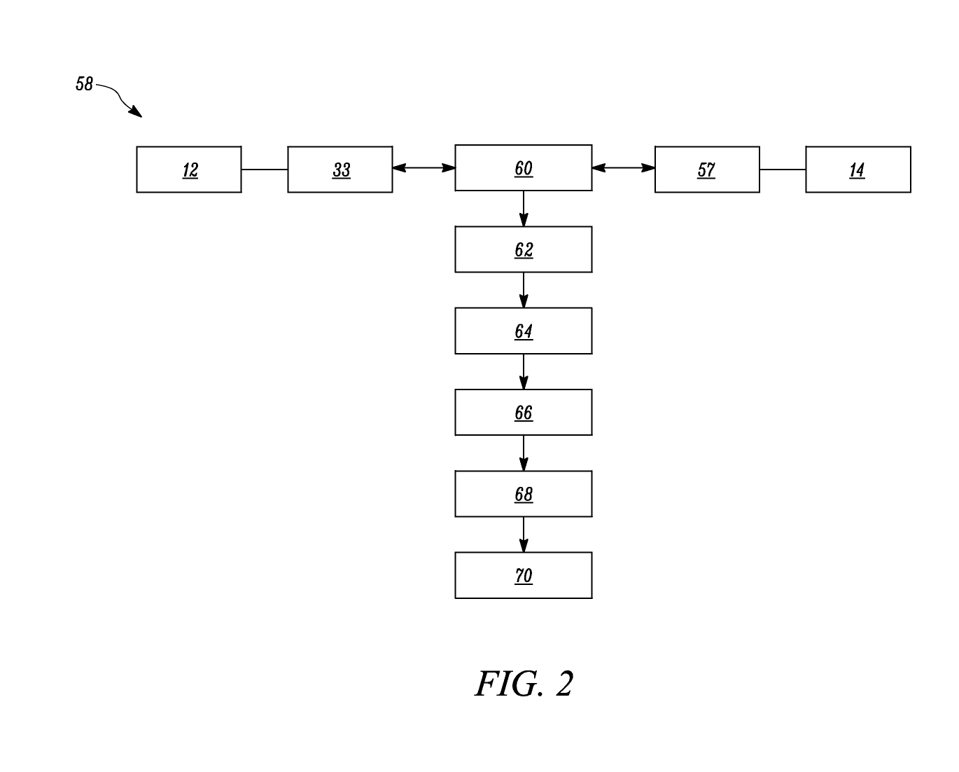

FIG. 2 shows a block diagram of a system 58 for performing the pushing or the pulling operation between the first machine 12 and the second machine 14 to minimize impact during the pushing or the pulling operation at the worksite 10. The system 58 initiates the communication between the first machine 12 and the second machine 14 for performing the pushing or pulling operation in the worksite 10. The system 58 initiates the communication between the first machine 12 and the second machine 14 based on a threshold distance 63 at the worksite 10. In an example, the threshold distance 63 (FIG. 1) may be understood as a minimum distance required for initiating communication between the first machine 12 and the second machine 14. In an example, a location of the first machine 12 with respect to the second machine 14, vice versa, may be determined by using global positioning system (GPS). Thereafter, based on the location of the first machine 12 and the second machine 14 at the worksite 10, the threshold distance 63 is determined. For the purpose of illustration of the present disclosure, a pushing operation is considered between the second machine 14 and the first machine 12. In this case, the first machine 12 is adapted to push the second machine 14 in the worksite 10 for performing the earth moving operation by the second machine 14 on the ground surface 21. The system 58 for performing the pushing operation between the first machine 12 and the second machine 14 is initiated at block 60. At block 62, the first machine 12 approaches the second machine 14 within the threshold distance 63 (as shown in FIG. 1) of the second machine 14. When the first machine 12 is within the threshold distance 63 of the second machine 14, at block 64, the first machine 12 transmits information regarding one or more machine parameters of the first machine 12 to the second machine 14. In an example, machine parameters of the first machine 12 can include, but not limited to, slippage of the track 22, boom angle, angle of steering axle, the height and the angle of the blade 30, and command to the steering system 23. Further, machine parameters of the second machine 14 can include, but not limited to, slippage of the ground engaging members 50, command to the bowl 52, and command to the apron 45, the height and the angle of the blade 55. Particularly, the first controller 33 of the first machine 12 is configured to communicate one or more machine parameters of the first machine 12 with the second controller 57 of the second machine 14. Similarly, the first controller 33 of the first machine 12 also receives information regarding one or more machine parameters of the second machine 14. In an example, the operator of the second machine 14 receives inputs related to the one or more machine parameters of the first machine 12.

When the first machine 12 receives information from the second machine 14, at block 66, the information is processed by the first controller 33 of the first machine 12. The processed information is further provided to the operator of the first machine 12. In one example, the processed information is a position of an implement system 53 of the second machine 14, the command to the steering system 43 of the second machine 14, a payload of the second machine 14, and a cycle segment of the second machine 14. Also, the position of the implement system 53 includes the height and the angle of the blade 55 with respect to the frame of the second machine 14. It may also be contemplated that the position of the implement system 24 of the first machine 12, the command to the steering system 23 of the second machine 12, a payload of the first machine 12, and a cycle segment of the first machine 12 may be communicated to the second machine 14. Also, the position of the implement system 24 includes the height and the angle of the blade 30 with respect to the frame of the first machine 12. At block 68, the first machine 12 and the second machine 14 may be controlled based on one or more outputs. The one or more outputs may be determined based on the one or more machine parameters of the second machine 14 and the one or more parameters of the first machine 12.

Upon completion of the pushing operation, the first machine 12 and the second machine 14 move beyond the threshold distance 63 in the worksite 10. In such a case, at block 70, the first controller 33 of the first machine 12 and the second controller 57 of the second machine 14 stops communicating the machine parameters between the first machine 12 and the second machine 14. Although the description herein is explained with respect to the first machine 12 for initiating the communication between the first machine 12 and the second machine 14, it will be understood by one skilled in the art that the second machine 14 may also initiate the communication to perform the pushing or pulling operation.

In an example, the first controller 33 and the second controller 57 may be a processor that includes a single processing unit or a number of processing units. In this example, the first controller 33 may be implemented as one or more microprocessor, microcomputers, digital signal processor, central processing units, logic circuitries, and/or any device that is capable of manipulating signals based on operational instructions.

In an example, the cycle segment of the first machine 12 can be understood as a work cycle including a dig segment, a carry segment, a dump segment, and a return segment. In an example, the work cycle may also include various other segments apart from the aforementioned segments. For the purpose of description, the first controller 33 and the second controller 57 located remotely are considered to receive the signals indicative of the locations of the first machine 12 and the second machine 14 respectively, via a sensing unit.

### INDUSTRIAL APPLICABILITY

The present disclosure relates to the system 58 and a method 72 for controlling operations of the first machine 12 and the second machine 14 at the worksite 10. The method 72 is applicable to the first machine 12 and the second machine 14 operating at the worksite 10 where autonomous operation is desired. The communication between the first machine 12 and the second machine 14 facilitates the operators of the first machine 12 and the second machine 14 to control contact of the first machine 12 with the second machine 14 during the pushing or the pulling operations. Thus, an impact caused due to the contact of the first machine 12 with the second machine 14 during the pushing or the pulling operation is minimized. Further, the first machine 12 and the second machine 14 may be configured to be controlled in auto mode from a remote location.

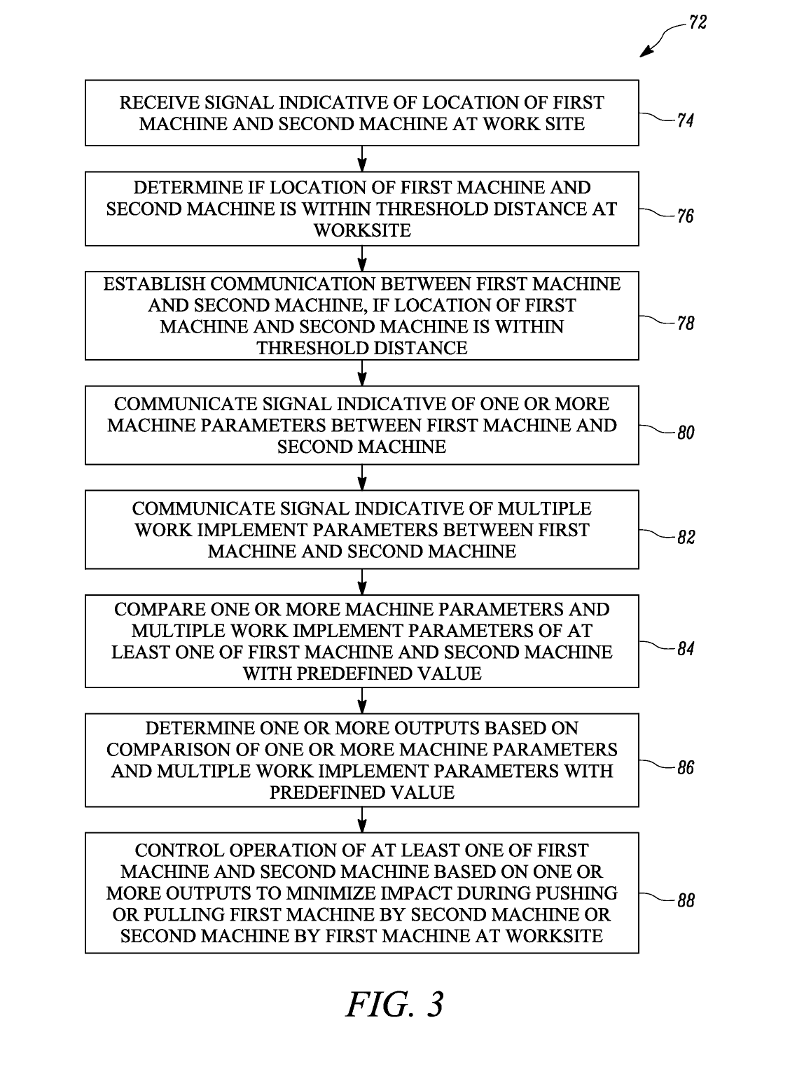

FIG. 3 illustrates a flowchart of the method 72 for controlling operations of the first machine 12 and the second machine 14 at the worksite 10. The first controller 33 of the first machine 12 and the second controller 57 of the second machine 14 are configured to control the operations between the first machine 12 and the second machine 14. At step 74, the method 72 includes receiving signals indicative of the location of the first machine 12 and the second machine 14 at the worksite 10. At step 76, the method 72 includes determining if the location of the first machine 12 and the second machine 14 is within the threshold distance 63 at the worksite 10. The threshold distance 63 is defined based on a predetermined area around at least one of the first machine 12 and the second machine 14. At step 78, the method 72 includes establishing a communication between the first machine 12 and the second machine 14. The communication between the first machine 12 and the second machine 14 is established if the location of the first machine 12 and the second machine 14 is within the threshold distance 63.

At step 80, the method 72 includes communicating signals indicative of one or more machine parameters between the first machine 12 and the second machine 14. The one or more machine parameters include ground speeds of the first machine 12 and the second machine 14. Further, the ground speeds are determined based on a slippage of the track 22 having track 22 of the first machine 12 and the second machine 14. At step 82, the method 72 includes communicating signals indicative of multiple implement parameters between the first machine 12 and the second machine 14. The multiple implement parameters include the position of the implement systems 24 and 53 of at least one of the first machine 12 and the second machine 14, respectively. The implement systems 24 and 53 are positioned at a certain adjustable height and at a certain adjustable angle with respect to the frames of at least one of the first machine 12 and the second machine 14, respectively. The multiple implement parameters further includes the command to the steering systems 23 and 43 of at least one of the first machine 12 and the second machine 14, respectively. The multiple implement parameters further includes the payload of at least one of the first machine 12 and the second machine 14. In an example, the phrase ‘payload’ can be understood as total weight of equipment carried by the first machine 12 or the second machine 14 to perform the predetermined tasks in the worksite 10. The multiple implement parameters further includes a cycle segment of at least one of the first machine 12 and the second machine 14.

At step 84, the method 72 includes comparing the one or more machine parameters and the multiple implement parameters of at least one of the first machine 12 and the second machine 14 with a predefined value. In an example, the predefined value may be understood as a value for the one or more machine parameters and the multiple implement parameters which is preset prior to initiating the communication between the first machine 12 and the second machine 14, to perform the pushing or pulling operation in the worksite 10. At step 86, the method 72 includes determining one or more outputs based on the comparison of the one or more machine parameters and the multiple implement parameters with the predefined value. At step 88, the method 72 includes controlling the operation of at least one of the first machine 12 and the second machine 14 based on the one or more outputs to minimize an impact caused during pushing or pulling the first machine 12 by the second machine 14 or the second machine 14 by the first machine 12 at the worksite 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for controlling operations of a first machine and a second machine at a worksite, the method comprising:
receiving a signal indicative of a location of the first machine and the second machine at the work site;
determining if the location of the first machine and the second machine is within a threshold distance at the worksite, wherein the threshold distance is defined based on a predetermined area around at least one of the first machine and the second machine;
establishing communication between the first machine and the second machine, if the location of the first machine and the second machine is within the threshold distance;
communicating signals indicative of one or more machine parameters between the first machine and the second machine, wherein the one or more machine parameters include ground speeds of the first machine and the second machine, wherein the ground speeds are determined based on a slippage of ground engaging members of the first machine and the second machine;
communicating signals indicative of multiple implement parameters between the first machine and the second machine, wherein the multiple implement parameters include;
a position of an implement system of at least one of the first machine and the second machine, wherein the position of the implement system includes a height and an angle of a blade with respect to a frame of at least one of the first machine and the second machine;
a command to a steering system of at least one of the first machine and the second machine;
a payload of at least one of the first machine and the second machine; and
a cycle segment of at least one of the first machine and the second machine;
comparing the one or more machine parameters and the multiple implement parameters of at least one of the first machine and the second machine with a predefined value;
determining one or more outputs based on the comparison of the one or more machine parameters and the multiple implement parameters with the predefined value; and
controlling the operation of at least one of the first machine and the second machine based on the one or more outputs to minimize an impact caused during pushing or pulling of the first machine by the second machine or the second machine by the first machine at the worksite.
